(19) United States
(12) Patent Application Publication
(10) Pub. No.: US 2003/0164760 A1
(43) Pub. Date: Sep. 4, 2003

(54) System and method for tire pressure monitoring using vehicle radio

(75) Inventors: John S. Nantz, Brighton, MI (US); Qingfeng Tang, Novi, MI (US); Riad Ghabra, Dearborn Heights, MI (US); David K. Carlson, Dearborn Heights, MI (US); William Jarvis, Plymouth, MI (US); Gerald Sheldon, South Lyon, MI (US)

Correspondence Address: BROOKS & KUSHMAN P.C. / LEAR CORPORATION, 1000 TOWN CENTER TWENTY-SECOND FLOOR, SOUTHFIELD, MI, 48075, US

(73) Assignee: LEAR CORPORATION, Southfield, MI

(21) Appl. No.: 10/219,127

(22) Filed: Aug. 15, 2002

Related U.S. Application Data
(60) Provisional application No. 60/360,762, filed on Mar. 1, 2002.

(51) Int. Cl. B60C 23/00

(52) U.S. Cl. 340/447

(57) ABSTRACT

A system and method for remote monitoring of tire pressure in a vehicle having multiple tires includes a controller mounted on the vehicle and provided in communication with a vehicle radio. The vehicle radio is for use in receiving wireless broadcast signals and includes a display. The controller generates tire information signals based on tire pressure data transmitted from each of the tires. The tire information signals are used by the vehicle radio to convey tire pressure information to a vehicle occupant using the vehicle radio display.

### CROSS REFERENCE TO RELATED APPLICATION

This application claims the benefit of U.S. provisional application Serial No. 60/360,762 filed on Mar. 1, 2002.

### BACKGROUND OF THE INVENTION

1. Field of the Invention

The present invention relates to a system and method for wireless vehicle tire pressure monitoring that uses a vehicle radio to convey information concerning tire parameters to a vehicle operator or occupant.

2. Background

It is known in the automotive industry to provide for wireless monitoring of vehicle tire parameters, particularly tire pressure. In such tire pressure monitoring systems, tire pressure sensors and radio frequency (RF) transmitters are mounted inside each tire, typically adjacent the inflation valve stem. In each tire, the tire pressure sensed by the tire pressure sensor is transmitted by the transmitter to a receiver/controller located on the vehicle. The tire pressure information delivered to the receiver/controller by the RF signals from the transmitters is subsequently conveyed to a vehicle operator or occupant, typically using a display unit. In such a fashion, tire pressure monitoring systems can help to improve vehicle safety. Exemplary tire pressure monitoring systems are described and shown in U.S. Pat. Nos. 6,112,587 and 6,034,597.

Display units for use in current tire pressure monitoring systems are mounted inside the vehicle passenger compartment and typically convey at least tire pressure information to the vehicle operator. Such display units may comprise a Light Emitting Diode (LED) display or a lighted icon in the vehicle dashboard or a vehicle console. Alternatively, or in addition, audible means for conveying at least tire pressure information to the vehicle operator, such as tones or speech, may be used. Information concerning other tire parameters, such as tire location (i.e., front left (FL), front right (FR), rear left (RL), or rear right (RR)), temperature, speed and/or battery status, may also be conveyed to the vehicle operator. It should be noted that the information conveyed to the vehicle operator may include a warning, which may also be audible, if tire pressure, or other tire parameters, such as temperature, and/or battery status are outside recommended ranges.

Commercially available radios currently being installed as original equipment in many vehicles often include an LED or a liquid crystal display. Thus, in addition to conveying information or entertainment in an audible fashion via associated speakers, current vehicle radios also convey a variety of information in a visual fashion using such a display. Information conveyed via such a display may include local time, interior and/or exterior temperature, radio volume level, radio station frequency and/or other identification, song titles, etc.

As a result, it would be desirable to provide a system and method for monitoring tire pressure that utilizes a vehicle radio for conveying information concerning various tire parameters to a vehicle operator or occupant. Such a system and method would eliminate the need for a separate display unit for a tire pressure monitoring system, thereby reducing the costs associated with tire pressure monitoring systems and making such systems, and the improved vehicle safety associated therewith, available for use in a wider variety of vehicles.

### SUMMARY OF THE INVENTION

Accordingly, the present invention provides an improved system and method for vehicle tire pressure monitoring that utilizes a vehicle radio to convey information concerning various tire parameters to a vehicle operator or occupant.

According to the present invention, then, a system for remote monitoring of tire pressure in a vehicle having a plurality of tires is provided. The system comprises a plurality of transmitters, each transmitter for mounting in one of the plurality of tires and for transmitting tire pressure data. The system further comprises a controller for mounting on the vehicle, the controller to be provided in communication with a vehicle radio for use in receiving wireless broadcast signals, the vehicle radio having a display. The controller generates tire information signals based on the tire pressure data, the tire information signals for use by the vehicle radio to convey tire pressure information to a vehicle occupant using the display.

Also according to the present invention, a method is provided for remote monitoring of tire pressure in a vehicle having a plurality of tires. The method comprising providing a controller for mounting on the vehicle, the controller to be provided in communication with a vehicle radio for use in receiving wireless broadcast signals, the vehicle radio having a display. The controller generates tire information signals based on tire pressure data transmitted from each of the plurality of tires, the tire information signals for use by the vehicle radio to convey tire pressure information to a vehicle occupant using the display.

These and other features and advantages of the present invention will be readily apparent upon consideration of the following detailed description of the invention in conjunction with the accompanying drawings.

### BRIEF DESCRIPTION OF THE DRAWINGS

FIG. 1 is a simplified, representative block diagram of the system of the present invention for tire pressure monitoring using a vehicle radio to convey information concerning tire parameters to a vehicle operator; and

FIG. 2 is a simplified, representative flowchart of the method of the present invention for tire pressure monitoring using a vehicle radio to convey information concerning tire parameters to a vehicle operator.

### DETAILED DESCRIPTION OF THE PREFERRED EMBODIMENTS

Referring now to the Figures, the preferred embodiments of the present invention will now be described in detail. As previously noted, it is known in the automotive industry to provide for wireless monitoring of vehicle tire parameters, particularly tire pressure. In such tire pressure monitoring systems, tire pressure sensors and radio frequency (RF) transmitters are mounted inside each tire, typically adjacent the inflation valve stem. In each tire, the tire pressure sensed by the tire pressure sensor is transmitted by the transmitter to a receiver/controller located on the vehicle. The tire pressure information delivered to the receiver/controller by the RF signals from the transmitters is subsequently conveyed to a vehicle operator or occupant, typically using a display unit. In such a fashion, tire pressure monitoring systems can help to improve vehicle safety.

Display units for use in current tire pressure monitoring systems are mounted inside the vehicle passenger compartment and typically convey at least tire pressure information to the vehicle operator. Such display units may comprise a Light Emitting Diode (LED) display or a lighted icon in the vehicle dashboard or a vehicle console. Alternatively, or in addition, audible means for conveying at least tire pressure information to the vehicle operator, such as tones or speech, may be used. As described above, information concerning other tire parameters, such as tire location (i.e., front left (FL), front right (FR), rear left (RL), or rear right (RR)), temperature, speed and/or battery status, may also be conveyed to the vehicle operator. It should be noted that the information conveyed to the vehicle operator may include a warning, which may also be audible, if tire pressure, or other tire parameters, such as temperature, and/or battery status are outside recommended ranges.

As also noted previously, commercially available radios currently being installed as original equipment in many vehicles often include an LED or a liquid crystal display. Thus, in addition to conveying information or entertainment in an audible fashion via associated speakers, current vehicle radios also convey a variety of information in a visual fashion via such a display, which information may include local time, interior and/or exterior temperature, radio volume level, radio station frequency and/or other identification, song titles, etc.

Thus, as also previously noted, it would be desirable to provide a system and method for monitoring tire pressure that utilizes a vehicle radio for conveying information concerning various tire parameters to a vehicle system. Such a system and method would eliminate the need for a separate display unit for a tire pressure monitoring system, thereby reducing the costs associated with tire pressure monitoring systems and making such systems, and the improved vehicle safety associated therewith, available for use in a wider variety of vehicles.

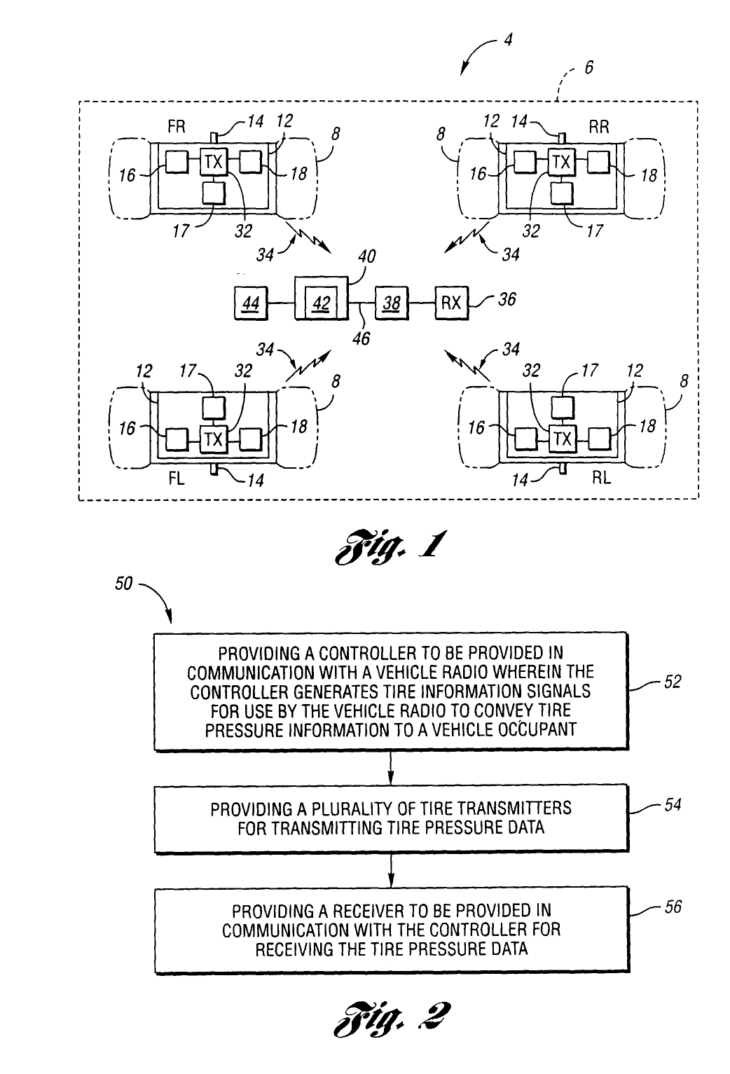

Referring now to FIG. 1, a simplified, representative block diagram of the system of the present invention for automatically identifying tire location in a tire pressure monitoring system is shown, denoted generally by reference numeral 4. As seen therein, the system (4) is designed for use in a vehicle (6) having a plurality of tires (8), each tire (8) having a rim (10). Each one of the plurality of tires (8) has a tire location associated therewith, such as front left (FL), front right (FR), rear left (RL), and rear right (RR). It should be noted here that while the present invention is described herein for use in an automotive vehicle having four tires, such an environment is exemplary only. That is, the present invention is suitable for use in any type of vehicle having any number of tires.

Referring still to FIG. 1, the system (4) preferably includes a plurality of tire monitors (12). Each tire monitor (12) is provided for mounting in one of the plurality of tires (8). In that regard, each tire monitor (12) is preferably mounted inside the tire (8) on rim (10) adjacent the tire inflation valve stem (14), although any mounting location known in the art may be used. Each tire monitor (12) preferably includes at least one sensors (16) and/or other device (not shown), for sensing, determining and/or monitoring at least the pressure of the associated tire (8). It should be noted, however, that each tire monitor (12) may also be equipped to sense, determine and/or monitor any number of additional tire parameters, such as temperature, status (i.e., whether the tire is rotating) and/or speed, in any fashion well known to those of ordinary skill in the art. For example, each tire monitor (12) may also include a temperature sensor (17) for use in sensing the temperature of the associated tire (8), as well as a rotation sensor (18) for use in sensing rotation of the associated tire (8).

Still referring to FIG. 1, each tire monitor (12) also includes a transmitter (32) in communication with pressure sensor (16), temperature sensor (17) and rotation sensor (18). Transmitters (32) transmit signals (34) to convey pressure data, temperature data, and status data for each tire (8). In that regard, signals (34) are preferably radio frequency (RF) signals, although other signal types known in the art, such as low frequency (LF) could be employed. Once again, it should be noted that transmitters (32) may also transmit, as part of or separate from signal (34), a signal or signals including data concerning any of a number of other tire parameters in addition to pressure, temperature and status, such as tire speed, as sensed, measured and/or determined by an appropriately equipped tire monitor (12).

It should also be noted that each tire monitor (12) also typically includes a battery (not shown), and that transmitters (32) may also transmit, again as part of or separate from signal (34), a signal or signals representative of the status of such a battery, including a low battery status. It should still further be noted that tire pressure monitoring system (4) may also be configured and/or programmed to determine, identify or recognize the particular tire location (e.g., front left (FL), front right (FR), rear left (RL), rear right (RR)) associated with an RF signal (34) received from a tire transmitter (32) in any fashion known in the art.

Referring still to FIG. 1, the tire pressure monitoring system (4) of the present invention also includes a receiver (36) for mounting on the vehicle (6) for receiving the signals (34) transmitted by transmitters (32). In that regard, receiver (36) may comprise one or more antenna (not shown) to be located at one or more selected sites on the vehicle (6).

Still referring to FIG. 1, the system (4) of the present invention further comprises a controller (38) for mounting on vehicle (6) and to be provided in communication with receiver (36). Controller (38), which preferably comprises an appropriately programmed microprocessor or DSP, is also for generating tire information signals (not shown) based on the tire pressure, temperature, status and/or other data received by receiver (36) from transmitters (32) for use in conveying at least tire pressure information to a vehicle operator. It should also be noted that receiver (36) and controller (38) may be part of a single control unit for mounting on vehicle (6).

According to the system (4) of the present invention, controller (38) is provided in communication with a vehicle radio (40) mounted in the passenger compartment of vehicle (6). Vehicle radio (40) may be any commercially available radio for use in receiving wireless broadcast signals from local radio stations, satellite transmission systems and/or any other source. Vehicle radio (40) includes a display unit (42) and has at least one associated speaker (44).

The tire information signals generated by controller (38) based on the tire pressure, temperature, status and/or other data received from transmitters (32) by receiver (36) and provided to controller (38) are sent to vehicle radio (40). Such tire information signals are for use by vehicle radio (40) to convey tire parameter information, including at least tire pressure information, to a vehicle operator or occupant (not shown). In that regard, such tire parameter information may be conveyed to the vehicle operator or occupant by vehicle radio (40) using display unit (42) and/or the at least on associated speaker (44).

As previously noted, display unit (42) of vehicle radio (40) may comprise an LED or liquid crystal display. It should also be noted that information concerning other tire parameters, such as temperature, speed and/or battery status, may also be conveyed by vehicle radio (40) to the vehicle operator using display unit (42) and/or the at least one associated speaker (44). It should still further be noted that the information conveyed to the vehicle operator may include a warning, which may also be audible, if tire pressure, or other tire parameters, such as temperature, and/or battery status are outside recommended ranges.

For example, vehicle radio (40) could use display unit (42) to display a particular tire location and the associated pressure and/or temperature of that tire. Alternatively, vehicle radio (40) could use associated speaker (44) to convey such information in an audible fashion, such as by using a speech synthesizer (not shown) or by concatenated voice recordings stored in a memory (not shown). The warnings described above may be conveyed similarly by the vehicle radio (40) using display unit (42) and/or speaker (44), and may include audible tones produced by vehicle radio (40) using speaker (44).

Preferably, for tire parameter information to be conveyed by vehicle radio (40) using speaker (44), any existing broadcast signal to vehicle radio (40) and speaker (44) is at least momentarily interrupted. Moreover, where vehicle radio (40) is not in currently in use, vehicle radio (40), including display unit (42) and associated speaker (44), may be at least momentarily be activated in order to convey tire parameter information to a vehicle occupant or operator.

As previously described, the system (4) preferably includes a receiver (36) for mounting on the vehicle (6) for receiving the signals (34) transmitted by transmitters (32). In that regard, receiver (36) may be integrated with vehicle radio (40). It should also be noted that vehicle receiver (40) includes a receiver (not shown) for receiving wireless broadcast signals. In order to further reduce costs associates with system (4), the receiver of vehicle radio (40) may also be used as the receiver (36) for use in the present invention for receiving signals (34) from transmitters (32).

Controller (38) and vehicle radio (40) are preferably provided in communication with each other using a data bus (46). In that regard, tire pressure, temperature, status and/or other data from signals (34) transmitted by transmitters (32) and provided to controller (38) by receiver (36) is preferably processed by controller (38) (e.g., decoded or decrypted) and converted to a bus signals (not shown), such as the tire information signals previously described, according to any known data transmission protocol. Vehicle radio (40), connected to data bus (46) and compatible with such data transmission protocol, collects such bus signals for use in conveying tire parameter information to a vehicle occupant or operator according to a programmed routine, such as previously described, and using display unit (42) and/or the at least one associated speaker (44).

Still referring to FIG. 1, each sensor (16, 17, 18) and/or transmitter (32) preferably has a unique identification code associated therewith. Such identification codes serve to particularly associate sensors (16, 17, 18) and/or transmitters (32) with vehicle (6). In that regard, each transmitter (32) also preferably transmits such identification code for receipt by receiver (36) and for use by controller (38) in determining that the signals (34) received by receiver (36) are associated with the vehicle (6). Transmitters (34) may transmit the identification codes as part of signal (34), or as a separate signal (not shown). In such a fashion, controller (38) disregards any tire information signals which may be transmitted from any nearby vehicle and received by receiver (36).

It should be noted that the pressure, temperature, status and/or other data may be transmitted by transmitters (32) together as part of a single signal (34). Alternatively, however, such data may be transmitted by transmitters (32) as separate signals (34). In that event, the previously described unique identification code associated with sensors (16, 17, 18) and/or transmitters (32) may be transmitted with the data for a particular tire (8) as part of the separate signals (34). In such a fashion, the pressure, temperature, status and/or other data may be properly associated by controller (38) with vehicle (6) and/or particular tire locations (i.e., Front Right (FR), Front Left (FL), Rear Right (RR), Rear Left (RL)).

Referring next to FIG. 2, a simplified, representative flowchart of the method of the present invention, denoted generally by reference numeral 50, is shown for remote monitoring of tire pressure using a vehicle radio to convey information concerning tire parameters to a vehicle occupant. As seen therein, the method (50) comprises providing (52) a controller for mounting on the vehicle, the controller to be provided in communication with a vehicle radio for use in receiving wireless broadcast signals, the vehicle radio having a display, wherein the controller generates tire information signals based on tire pressure data transmitted from each of the plurality of tires, the tire information signals for use by the vehicle radio to convey tire pressure information to a vehicle occupant using the display.

The method (50) may further comprise providing (54) a plurality of transmitters, each transmitter for mounting in one of the plurality of tires and for transmitting tire pressure data. In that regard, as previously described in detail in connection with FIG. 1, such transmitters may also transmit tire temperature, status and/or other data, and the controller may generate tire information signals based on the tire temperature, status and/or other data, where the tire information signals are for use by the vehicle radio to convey tire temperature information to the vehicle occupant using the display.

As previously described, the tire information signals may also be for use by the vehicle radio to convey tire location information to the vehicle occupant using the display. As also described above, the pressure, temperature, status and/or other data may be transmitted by transmitters together as part of a single RF signal, or as separate RF signals.

Still referring to FIG. 2, the method (50) of the present invention may further comprise providing (56) a receiver for mounting on the vehicle, the receiver to be provided in communication with the controller and for receiving the tire pressure, temperature, status and/or other data transmitted by the transmitters. In that regard, as previously described in detail in connection with FIG. 1, the vehicle radio itself may comprises a receiver for receiving the tire pressure, temperature, status and/or other data transmitted by the transmitters.

As also described in detail above in connection with FIG. 1, the vehicle radio preferably has at least one speaker associated therewith, and the tire information signals are for use by the vehicle radio to convey tire pressure, temperature, status and/or other information to the vehicle occupant using the at least one speaker. In that regard, the tire information signals may be for use by the vehicle radio to convey tire location information to the vehicle occupant using the at least one speaker.

It should also be noted that the controller is preferably provided in communication with the vehicle radio over a data bus. Tire pressure, temperature, status and/or other data from RF signals transmitted by each tire transmitter and provided to the controller by the receiver is preferably decoded by the controller and converted to a bus signals, such as the tire information signals previously described. The vehicle radio collects such bus signals for use in conveying tire parameter information to a vehicle occupant or operator using display unit and/or the associated speaker.

As also described above in connection with FIG. 1, according to the method (50) of the present invention, each transmitter provided preferably has a unique identification associated therewith, and each transmitter is also for transmitting the associated identification for use in determining whether tire pressure data is associated with the vehicle and/or determining a tire location in the fashion previously described. As also described above, each transmitter is preferably provided in communication with pressure, temperature and rotation sensors for sensing tire pressure, temperature and status and for use by the transmitter for transmitting tire pressure, temperature and status data. Each transmitter, pressure sensor, temperature sensor and rotation sensor together comprise a tire monitor to be mounted in the tire as described in detail above in connection with FIG. 1.

It should be noted that the simplified flowchart depicted in FIG. 2 is exemplary of the method (50) of the present invention. In that regard, the method (50) may be executed in sequences other than those shown in FIG. 2, including the execution of a subset of the steps shown and/or the execution of one or more steps simultaneously.

From the foregoing description, it can be seen that the present invention provides an improved system and method for vehicle tire pressure monitoring that utilizes a vehicle radio to convey information concerning various tire parameters to a vehicle operator or occupant. The present invention eliminates the need for a separate display unit for a tire pressure monitoring system, thereby reducing the costs associated with tire pressure monitoring systems and making such systems, and the improved vehicle safety associated therewith, available for use in a wider variety of vehicles.

While various embodiments of the invention have been illustrated and described, it is not intended that these embodiments illustrate and describe all possible forms of the present invention. Rather, the words used in the specification are words of description rather than limitation, and it is understood that various changes may be made without departing from the spirit and scope of the invention. Indeed, many alternatives, modifications, and variations will be apparent to those skilled in the art in light of the foregoing description, and the present invention is intended to embrace all such alternatives.

What is claimed is:

1. A system for remote monitoring of tire pressure in a vehicle having a plurality of tires, the system comprising:
a plurality of transmitters, each transmitter for mounting in one of the plurality of tires and for transmitting tire pressure data; and
a controller for mounting on the vehicle, the controller to be provided in communication with a vehicle radio for use in receiving wireless broadcast signals, the vehicle radio having a display, wherein the controller generates tire information signals based on the tire pressure data, the tire information signals for use by the vehicle radio to convey tire pressure information to a vehicle occupant using the display.

2. The system of claim 1 wherein the transmitters are also for transmitting tire temperature data, the controller generates tire information signals based on the tire temperature data, and the tire information signals are for use by the vehicle radio to convey tire temperature information to the vehicle occupant using the display.

3. The system of claim 1 wherein the tire information signals are for use by the vehicle radio to convey tire location information to the vehicle occupant using the display.

4. The system of claim 1 further comprising a receiver for mounting on the vehicle, the receiver to be provided in communication with the controller and for receiving the tire pressure data transmitted by the transmitters.

5. The system of claim 2 further comprising a receiver for mounting on the vehicle, the receiver to be provided in communication with the controller and for receiving the tire pressure and temperature data transmitted by the transmitters.

6. The system of claim 1 wherein the radio comprises a receiver for receiving the tire pressure data transmitted by the transmitters.

7. The system of claim 2 wherein the radio comprises a receiver for receiving the tire pressure and temperature data transmitted by the transmitters.

8. The system of claim 1 wherein the radio has at least one speaker associated therewith, and the tire information signals are for use by the vehicle radio to convey tire pressure information to the vehicle occupant using the at least one speaker.

9. The system of claim 2 wherein the radio has at least one speaker associated therewith, and the tire information signals are for use by the vehicle radio to convey tire pressure and temperature information to the vehicle occupant using the at least one speaker.

10. The system of claim 8 wherein the tire information signals are for use by the vehicle radio to convey tire location information to the vehicle occupant using the at least one speaker.

11. The system of claim 1 wherein the controller is provided in communication with the vehicle radio over a data bus.

12. The system of claim 1 wherein the controller is provided in communication with the vehicle radio over a data bus, and the controller converts the tire temperature data to the tire information signal for transmission to the vehicle radio over the data bus.

13. A method for remote monitoring of tire pressure in a vehicle having a plurality of tires, the method comprising providing a controller for mounting on the vehicle, the controller to be provided in communication with a vehicle radio for use in receiving wireless broadcast signals, the vehicle radio having a display, wherein the controller generates tire information signals based on tire pressure data transmitted from each of the plurality of tires, the tire information signals for use by the vehicle radio to convey tire pressure information to a vehicle occupant using the display.

14. The method of claim 13 further comprising providing a plurality of transmitters, each transmitter for mounting in one of the plurality of tires and for transmitting tire pressure data.

15. The method of claim 14 wherein the transmitters are also for transmitting tire temperature data, the controller generates tire information signals based on the tire temperature data, and the tire information signals are for use by the vehicle radio to convey tire temperature information to the vehicle occupant using the display.

16. The method of claim 13 wherein the tire information signals are for use by the vehicle radio to convey tire location information to the vehicle occupant using the display.

17. The method of claim 13 further comprising providing a receiver for mounting on the vehicle, the receiver to be provided in communication with the controller and for receiving the tire pressure data transmitted by the transmitters.

18. The method of claim 15 further comprising a receiver for mounting on the vehicle, the receiver to be provided in communication with the controller and for receiving the tire pressure and temperature data transmitted by the transmitters.

19. The method of claim 13 wherein the radio comprises a receiver for receiving the tire pressure data transmitted by the transmitters.

20. The method of claim 15 wherein the radio comprises a receiver for receiving the tire pressure and temperature data transmitted by the transmitters.

21. The method of claim 13 wherein the radio has at least one speaker associated therewith, and the tire information signals are for use by the vehicle radio to convey tire pressure information to the vehicle occupant using the at least one speaker.

22. The method of claim 15 wherein the radio has at least one speaker associated therewith, and the tire information signals are for use by the vehicle radio to convey tire pressure and temperature information to the vehicle occupant using the at least one speaker.

23. The method of claim 21 wherein the tire information signals are for use by the vehicle radio to convey tire location information to the vehicle occupant using the at least one speaker.

24. The method of claim 13 wherein the controller is provided in communication with the vehicle radio over a data bus.

25. The method of claim 13 wherein the controller is provided in communication with the vehicle radio over a data bus, and the controller converts the tire temperature data to the tire information signal for transmission to the vehicle radio over the data bus.
